(19) United States
(12) Patent Application Publication
(10) Pub. No.: US 2025/0332871 A1
(43) Pub. Date: Oct. 30, 2025

(54) PROGRAMMING METHOD FOR PRESSURE SENSORS OF VEHICLE TIRES

(71) Applicant: ATEQ, Les Clayes-sous-Bois (FR)

(72) Inventor: Bruno Rousseau, Les Clayes-sous-Bois (FR)

(21) Appl. No.: 19/183,665

(22) Filed: Apr. 18, 2025

(30) Foreign Application Priority Data
Apr. 29, 2024 (FR) FR2404441

(51) Int. Cl. B60C 23/04

(52) U.S. Cl. CPC B60C 23/0415

(57) ABSTRACT

The present invention relates to a programming method for pressure sensors of vehicle tires, comprising:
an activation of at least one programmable pressure sensor;
a reception of at least one signal from said at least one pressure sensor after said activation;
a determination of a current position in the vehicle of said at least one activated pressure sensor;
a research in a database of a pair stored identifier-stored position, in which the stored position is the current position of said pressure sensor; and
a programming of said at least one pressure sensor with the stored identifier.

This application claims the benefit of priority to French Patent Application No. FR2404441, filed on Apr. 29, 2024, which is hereby incorporated by reference in its entirety.

The present invention relates to a programming method for pressure sensors of vehicle tires. The invention also relates to a programming device configured to implement said programming method. It finds application in particular, but not restrictively, in the field of electronic systems for monitoring the pressure of tires for automotive vehicles (“tire pressure monitoring systems”, TPMS), in particular for trucks.

In particular, said programming device makes it possible to activate, communicate and/or reprogram at least one element of the electronic tire pressure monitoring system (this type of device is sometimes also called valve trigger TPMS), notably pressure sensors of said systems.

In a manner known by a person skilled in the art, the tire pressure monitoring system comprises an onboard computer housed in the vehicle and at least one pressure sensor located in the tires, thus measuring the inner pressure of the tires, and configured to communicate this pressure value to the onboard computer of the vehicle. The onboard computer can thus warn the user of the vehicle if one of the tires happens to burst or deflate, which leads to security hazard.

In general, to find out the position of the pressure sensor in a tire, the onboard computer of the vehicle launches a re-learning of the position. To do so, a learning tool is used, which is called a TPMS tool and activates the various pressure sensors to determine their unique identifier and their position in the vehicle, and this pair identifier-position is updated in a memory of the onboard computer by transmitting it through an OBD connection between the TPMS tool and the onboard computer.

For security reasons, when a tire is worn out, it is necessary to change it for a new tire. This change can be made by any maintenance service. The new tire includes a new pressure sensor without an identifier known by the onboard computer.

A drawback of this prior state of the art is that, in the case of a truck, the change of a tire may be made any time, for example on the road during the travel of the truck, and the driver may call for any maintenance service, which will take action on the road to change the tire for a new tire and a new sensor. Yet, such maintenance services generally have no access to the truck cabin for security reasons, hence cannot connect to the onboard computer of the vehicle through OBD connection to update the new pressure sensor with an identifier and a position matching the new tire where it is housed. Similarly, for security reasons, these maintenance services cannot connect through a wireless link to the onboard computer of the truck. Furthermore, the onboard computer is often turned off when a maintenance service intervene.

In this context, the present invention aims at proposing a programming method for pressure sensors of vehicle tires, which makes it possible to solve the above-mentioned drawback.

To do so, the invention suggests a programming method for pressure sensors of vehicle tires, said programming method comprising:
an activation of at least one programmable pressure sensor;
a reception of at least one signal from said at least one pressure sensor after said activation;
a determination of a current position in the vehicle of said at least one activated pressure sensor;
a research in a database of a pair stored identifier-stored position, in which the stored position is the current position of said pressure sensor,
a programming of said at least one pressure sensor with the stored identifier.

According to non-limiting embodiments, said programming method can further comprise at least one additional characteristic, alone or according to any technically possible combination among the following ones.

According to a non-limiting embodiment, said database is in a remote server or a memory of a programming device.

According to a non-limiting embodiment, said programming device is a TPMS tool.

According to a non-limiting embodiment, said stored identifier is an identifier that is stored in an onboard computer of said vehicle and said stored position is a position stored in said onboard computer.

According to a non-limiting embodiment, said stored identifier is an identifier of a non-programmable pressure sensor.

According to a non-limiting embodiment, each step of the programming method is made in sequence for all pressure sensors of said vehicle before the following step, wherein all the steps of the programming method are made for each pressure sensor of said vehicle before moving on to the next pressure sensor.

According to a non-limiting embodiment, said pair is stored in the database according to a standard and said programming method further comprises, before the step of research of said pair in said database, a research in said database of said standard.

According to a non-limiting embodiment, said standard is defined among:
a vehicle identification number,
a vehicle license plate,
a communication protocol of said pressure sensor,
a configuration of the tires.

According to a non-limiting embodiment, the determination of the current position is made in a given sequence.

According to a non-limiting embodiment, the given sequence is preset by the programming device.

According to a non-limiting embodiment, the given sequence is set by an operator and the programming device is configured to ask the operator which sequence has been defined.

According to a non-limiting embodiment, the programming is made by the programming device sending a programming signal comprising the stored identifier to the pressure sensor.

It is further also suggested a programming device of pressure sensors for electronic tire pressure monitoring system of a vehicle, wherein said programming device comprises:
(a)—an enabling module configured to activate said pressure sensor;
(b)—a reception module configured to receive at least one signal from said pressure sensor after said activation;
(c)—an electronic unit configured to:
determine a current position in the vehicle of said activated pressure sensor,
search in a database a pair stored identifier-stored position, in which the stored position is the current position of said pressure sensor,
achieve a programming of said at least one pressure sensor with the stored identifier.

According to a non-limiting embodiment, said programming device comprises said database, in which the pair is stored.

According to a non-limiting embodiment, said electronic module is further configured, prior to the activation of said pressure sensor, to search said database for a standard according to which said pair is stored in said database.

According to a non-limiting embodiment, said standard is defined among:
a vehicle identification number,
a vehicle license plate,
a communication protocol of said pressure sensor,
a configuration of the tires.

According to a non-limiting embodiment, said programming device is a TPMS tool.

It is further suggested a computer software product comprising at least one sequence of instructions executable by a data treatment module, wherein the execution of said sequences of instructions makes it possible to implement the following steps when said sequences of instructions are loaded onto a computer, the steps being:
an activation of at least one programmable pressure sensor;
a reception of at least one signal emitted at the activation of said at least one pressure sensor;
a determination of the current position in the vehicle of said at least one activated pressure sensor;
a research in a database of a pair stored identifier-stored position, in which the stored position is the current position of said pressure sensor,
a programming of said at least one pressure sensor with the stored identifier.

According to a non-limiting embodiment, said sequences of instructions are uploaded into a programming device of pressure sensors for electronic tire pressure monitoring system of a vehicle.

It is further proposed a non-transitory computer-readable data recording medium, in which instructions are stored that, when implemented by a data treatment module, make said data treatment module implement the programming method as described in any previous characteristic.

It is further suggested a maintenance method for a vehicle, wherein said vehicle comprises an electronic tire pressure monitoring system of said vehicle and said tires, said tires each comprising a pressure sensor, characterized in that said maintenance method comprises:
a change of at least one tire in said vehicle with a new tire,
an implementation of the programming method according to any one of the previous characteristics.

The invention shall be better understood, and other goals, details, features and advantages shall appear more clearly in the following description of specific embodiments of the invention, which are introduced only for information and non-restrictively, with reference to the appended picture, where:

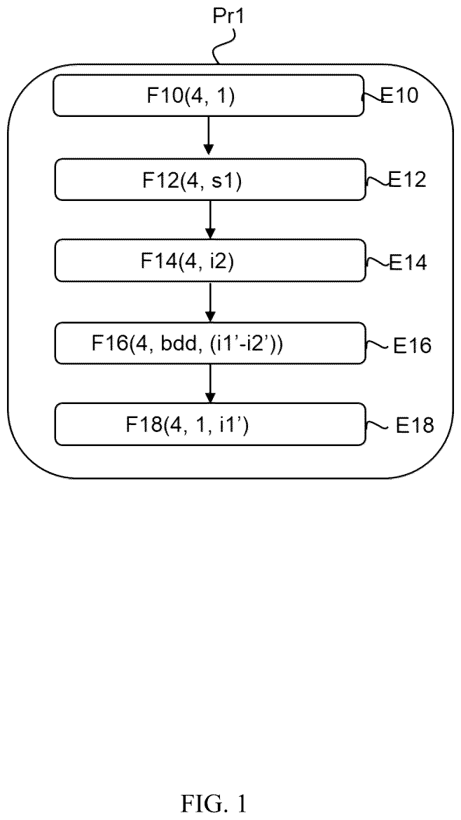

FIG. 1 is a flowchart that shows a programming method for pressure sensors of vehicle tires according to a non-limiting embodiment of the invention,

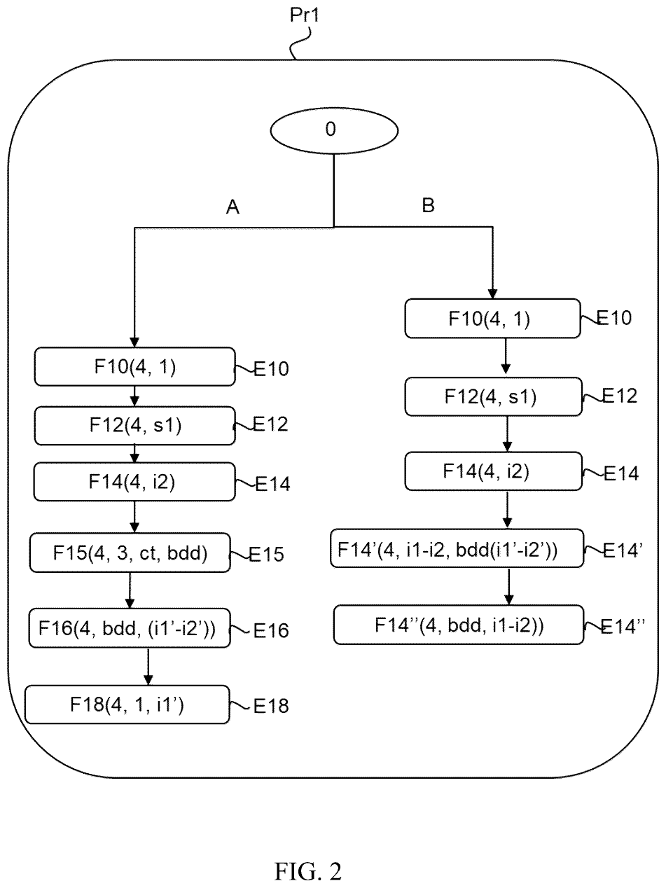

FIG. 2 shows the programming method of FIG. 1, wherein said programming method comprises additional steps according to non-limiting embodiments,

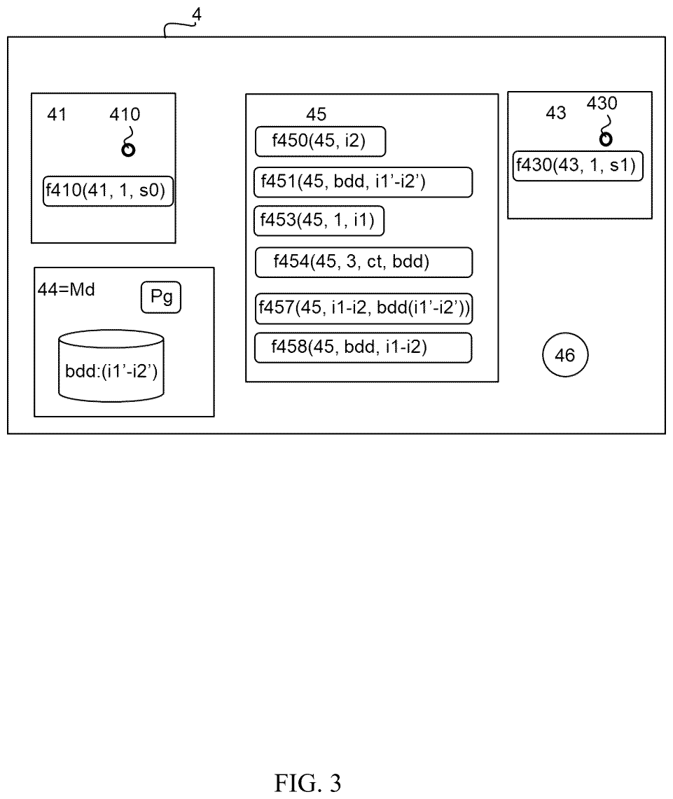

FIG. 3 is a very schematical representation of a device for programming pressure sensors with the various functions it implements, said programming device being configured to implement the programming method of FIG. 1 or 2,

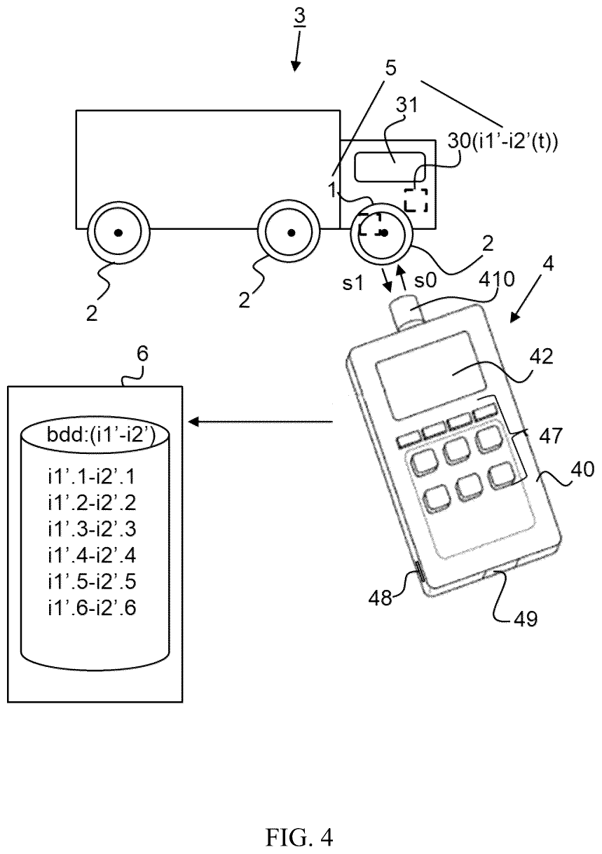

FIG. 4 is a view of the programming device of FIG. 3, which cooperates with a pressure sensor of an electronic tire pressure monitoring system of a vehicle,

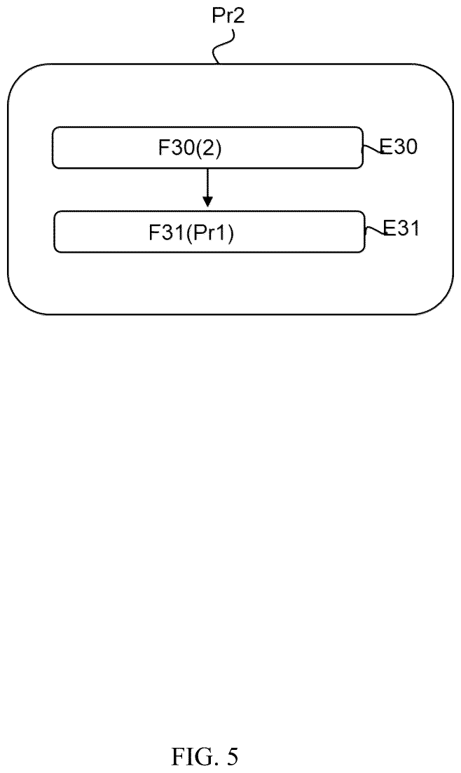

FIG. 5 is a flowchart for a maintenance method for a vehicle, wherein said vehicle comprises an electronic tire pressure monitoring system of the vehicle and said tires.

Identical items, structurally or functionally, which appear on different figures, keep the same references, unless otherwise specified.

The programming method Pr1 for pressure sensors 1 of vehicle 3 tires 2 according to the invention is described with reference to FIGS. 1 and 2. It is implemented by a programming device 4 as shown in FIGS. 3 and 4.

In a non-limiting embodiment, the vehicle 3 is an automotive vehicle. In non-limiting embodiments, the automotive vehicle 3 is a vehicle with a combustion engine, an electric engine or a hybrid engine. The vehicle 3 is pictured in FIG. 4. It is equipped with tires 2, where pressure sensors 1 are located. There is only one pressure sensor 1 per tire 2. Pressure sensors 1 are programmable pressure sensors 1. Namely, they comprise a programmable, namely rewritable memory. In non-limiting examples, this memory is a EEPROM or Flash or FRAM memory.

The vehicle 3 further comprises an electronic monitoring module 30 (pictured in FIG. 4) called ECU later in the description, also called onboard computer 30. The words electronic monitoring module 30 or onboard computer 30 are used in an undifferentiated way later in the description. The set pressure sensor 1—onboard computer 30 is called tire pressure monitoring system (TPMS) and referenced 5 in FIG. 4.

In a non-limiting embodiment, the vehicle 3 is a truck. This non-limiting example is the one considered below in the description. The onboard computer 30 is accessible via a cabin 31 (pictured in FIG. 4) of the truck 3.

Each pressure sensor 1 is typically equipped with a radiofrequency emitter to transmit data to the electronic monitoring module 30. Thus, the electronic monitoring module 30 that receives the data from the pressure sensors 1 can warn a user of the vehicle 3 if one of the tires 2 happens to burst or deflate, thus can prevent any risk for the security of the user of the truck 3.

It shall be noted that each pressure sensor 1 is configured to communicate according to a peculiar communication protocol with the electronic monitoring module 30 of the vehicle 3. Thus, a peculiar communication protocol is defined according to the type (mark and model) of a pressure sensor 1. According to the type of vehicle 3, each vehicle comprises one or several types of pressure sensors 1.

The current position of the pressure sensor 1 is the one of the tire 2 where it is located. The pressure sensor 1 comprises an unique identifier i1, thus a current position i2. Thus, the position of each pressure sensor 1 matches the true position of each corresponding tire 2 on the vehicle 3.

It shall be noted that the identifier i1 and its current position i2 are written in the programmable memory of the pressure sensor 1. Furthermore, the onboard computer 30 comprises, stored in memory, a set of pairs each associated with a pressure sensor 1, wherein a pair comprises the identifier of the pressure sensor 1 and a position of the corresponding tire 2 on the truck 3 at a given time t. The pair is noted i1′-i2′, where i1′ is the stored identifier and i2′ is the stored position at the given time t.

Thanks to the pressure sensor 1, the onboard computer 30 can manage the corresponding tire 2 and warn the user if the corresponding tire 2 has an issue such as, in non-limiting examples, a pressure issue, a temperature issue or a wear issue (according to the pressure).

The stored position i2′ of a pressure sensor 1 allows the onboard computer 30 to know which tire 2 it is, namely the front right, front left, rear right, rear left tire, possibly center right or center left tire in the case of a truck 3 with six tires 2 in a non-limiting example. The example with six tires 2 is considered as a non-limitative example below in the description.

Thus, for example, in the non-limiting example with six tires 2, the onboard computer 30 has stored the following data in each pressure sensor 1:
a stored identifier i1′.1 of a first pressure sensor 1 with value 1 associated with the stored front right position i2′.1 of a corresponding first tire 2,
a stored identifier i1′.2 of a second pressure sensor 1 with value 2 associated with the stored front left position i2′.2 of a corresponding second tire 2,
a stored identifier i1′.3 of a third pressure sensor 1 with value 3 associated with the stored center right position i2′.3 of a corresponding third tire 2,
a stored identifier i1′.4 of a fourth pressure sensor 1 with value 4 associated with the stored center left position i2′.4 of a corresponding fourth tire 2,
a stored identifier i1′.5 of a fifth pressure sensor 1 with value 5 associated with the stored rear right position i2′.5 of a corresponding fifth tire 2,
a stored identifier i1′.6 of a sixth pressure sensor 1 with value 6 associated with the stored rear left position i2′.6 of a corresponding sixth tire 2.

The values are given as non-limiting examples. Thus, if the onboard computer 30 queries the first pressure sensor 1 with its stored identifier i1′.1, it retrieves a pressure, for example, and associates it to the stored position i2′ in memory, hence to the tire 2, whose stored position i2′ is front right. Thus, it will correlate the retrieved pressure and the front right tire 2, and it will warn the user that the pressure in the front right tire 2 is problematical, if that's the case.

So, for each pressure sensor 1, there is a pair i1′-i2′ stored in the onboard computer 30. This way, all pairs i1′-i2′ are stored in the onboard computer 30, but also in a distant database bdd remote from the onboard computer 30 as pictured in FIG. 4. For each pressure sensor 1, the latest pair recorded in the database bdd is the same as the one in the onboard computer 30. As is seen below, in case of change of a tire 2 for a new tire 2, the identifier i1 of the relevant pressure sensor 1 is reprogrammed according to this database bdd, thus all that is stored in the onboard computer 30, without needing an access to the onboard computer 30.

A truck 3 usually drives long distance. So, for security reasons, if they are worn out, it is useful to change the tires 2 with new tires 2.

When changing a tire 2 of the truck 3 with a new tire 2, the previous pressure sensor 1 corresponding with the previous tire 2 is also changed with a new pressure sensor 1. This new pressure sensor 1 does not have an identifier i1 with a format that the onboard computer 30 of the truck can recognize, hence that the onboard computer 30 does not know. So, if it wants to communicate, it won't be possible without an identifier.

So that the onboard computer 30 can always warn the user if a tire 2 is problematic in any way, thus preventing the onboard computer 30 from providing false information, it is necessary that it can always identify it with the identifier i1 of the corresponding pressure sensor 1.

The programming method Pr1 makes it possible without a third party from outside accessing the onboard computer 30 of the truck 3 (by accessing the cabin 31 of the truck 3 or through a wireless link from the outside of the cabin 31).

Thus, as pictured in FIG. 1, the programming method Pr1 comprises the following steps.

In a step E10 noted F10(4,1), the programming device 4 activates a pressure sensor 1. The activation activates the pressure sensor 1. When activated, the pressure sensor 1 emits at least one signal s1. This signal is a confirmation of activation. With this signal, the pressure sensor 1 also specifies that it is ready for programming.

In a step E12 noted F12(4, s1), after said activation, the programming device 4 receives at least one signal s1 from said at least one pressure sensor 1.

In a step E14 noted F14(4, i2), the programming device 4 determines the current position i2 in the truck 3 of the activated pressure sensor 1.

The determination of the current position i2 is made in a given sequence. Thus, in a non-limiting example, the sequence is: front right, front left, center right, center left, rear right, rear left, in the non-limiting example of six tires 2.

In a first non-limiting embodiment, the sequence is preset by the programming device 4. The current position i2 is then known by the programming device 4. In this case, the programming device 4 is configured to display this preset order on a display device 42, so that the operator takes a stand in front of each pressure sensor 1 and activates them in this preset order.

In a second non-limiting embodiment, the sequence is determined by the operator, who takes a stand in front of each pressure sensor 1 according to their self-decided order, and activates them in this order. In this case, the programming device 4 is configured to ask the operator the order they decided via the display device 42. The operator can then input the defined order via a keyboard 47 in a non-limiting example, thus the programming device 4 determines the current position i2 of each pressure sensor 1.

In a step E16 noted F16(4, bdd, (i1′-i2′)), the programming device 4 searches in a database bdd a pair i1′-i2′ stored identifier-stored position, in which the stored position i2′ is the current position i2 of said pressure sensor 1.

In a non-limiting embodiment, said database bdd is in a remote server 6 (as pictured in FIG. 4) or is an embedded database in a memory 44 of the programming device 4 (as pictured in FIG. 3). In another non-limiting embodiment, it can be in a remote server 6 and in the memory 44 of the programming device 4 as well. In the case where the database bdd is in a remote server 6, the programming device 4 is configured to communicate with this remote server 6, hence to access said database bdd.

The database bdd comprises a set of pairs i1′-i2′ stored identifier-position of the tire 2 that are the latest recorded in the onboard computer 30. Thus, it constitutes a copy of the memory of the onboard computer 30 about the pairs i1′-i2′. Thus, in the non-limiting example of FIG. 4, it comprises the six pairs i1′. 1-i2′.1 to i1′.6-i2′.6 described above.

In a non-limiting embodiment, the stored identifier i1′ is an identifier of a non-programmable pressure sensor, namely which comprises a non-modifiable non-rewritable memory such as, in a non-limiting embodiment, a ROM memory. Namely, this is a pressure sensor that is mounted on the tire 2 as original equipment, thus it is the original pressure sensor, while the new pressure sensor 1 is a pressure sensor that was mounted on the tire 2 as an aftermarket to replace the original pressure sensor.

In a step E18 noted F18(4, i1, i1′), the programming device 4 programs the pressure sensor 1 that was changed with the stored identifier i1′ of the pair i1′-i2′. The programmable memory of the pressure sensor 1 is modified with the value of the stored identifier i1′, which becomes the new value of the identifier i1. Thus, the activated pressure sensor 1 comprises a new identifier i1 that the onboard computer 30 of the truck 3 can recognize. The programming is made by the programming device 4 sending a programming signal comprising the stored identifier i1′ to the pressure sensor 1. In a non-limiting embodiment, the programming signal is a low frequency signal. In a non-limiting embodiment, the low frequency signal is a signal emitted at 125 kHz. In another non-limiting embodiment, the programming signal is a Bluetooth™ signal. In a non-limiting embodiment, the emission of the programming signal is made according to the BlueTooth Low Energy™ communication protocol, referenced with the BLE acronym. Thus, the programming signal is a signal called BLE.

It shall be noted that the database bdd comprises the pairs stored identifier-position of the tires 2 of the pressure sensors 1 as original equipment or as an aftermarket. In this last case, the stored identifier i1′ of the pressure sensor of original equipment has been copied into the programmable pressure sensor.

The steps E10 to E18 described above are implemented for all the pressure sensors 1, whose tires 2 have been changed.

According to a first non-limiting embodiment, each step of the programming method Pr1 is made in sequence for all pressure sensors 1 of the truck 3 (that have been changed) before the following step. Thus, for example, all these pressure sensors 1 are activated before determining the current position i2 of the pressure sensors 1. Thus, for example, the current positions i2 of all the activated pressure sensors 1 are determined before searching in the database bdd.

In a second non-limiting embodiment, all the steps of the programming method Pr1 are made for each pressure sensor 1 of the truck 3 (that has been changed) individually before the following pressure sensor 1 (that has been changed). Thus, a first pressure sensor 1 is activated, its current position i2 is determined, the research in the database bdd for a pair i1′-i2′ is implemented, and the pressure sensor 1 is reprogrammed with the stored identifier i1′ before implementing the same steps for the following pressure sensor 1. In a non-limiting embodiment, the steps are implemented according to a preset sequence. Thus, in a non-limiting example, the sequence specifies beginning with the front right pressure sensor 1, then the front left one, then the center right one, then the center left one, then the rear right one, then the rear left one. In a non-limiting embodiment, the sequence is preset in the programming device 4. In this case, in a non-limiting example, when the operator launches the programming method Pr1 thanks to the programming device 4, it displays on its display device 42 a message with said sequence to guide the operator.

The programming method Pr1 comprises additional non-limiting steps as pictured in FIG. 2.

In a non-limiting embodiment (branch B as pictured in FIG. 2), before any change of tire 2, hence before any change of pressure sensor 1 in the vehicle 3, the programming method Pr1 comprises, for each pressure sensor 1, the completion of the steps of activation E10, of reception of said at least one signal s1 E12, of determination of said current position i2 E14, and for each pressure sensor 1:
a step E14′ noted F14′(4, i1-i2, bdd(i1′-i2′)) of comparison of the identifier i1 and of the current position i2 of said pressure sensor 1 of said vehicle 3 with all the pairs i1′-i2′ that are stored in said database bdd,
a step E14″ noted F14″(4, bdd, i1-i2) if no stored identifier i1′ of said pairs i1′-i2′ matches the identifier i1, updating the database bdd with a new pair made of said identifier i1 and the current position i2.

This makes it possible to keep the database bdd up to date or to build it up, hence to get an accurate database bdd.

These additional steps E14′ and E14″ are implemented by the programming device 4. It shall be noted that the operator who maintains the truck 3 and uses the programming device 4 knows that he or she changed the tires 2 of the truck 3 or not.

In a non-limiting embodiment, the following additional steps are implemented after a change of position of the tires 2 of the truck 3 (branch A as pictured in FIG. 2). It shall be noted that in FIG. 2, the bubble with a 0 shows the start of the programming method Pr1.

The database bdd relates to the pressure sensors 1 that are mounted in various vehicles 3.

In a non-limiting embodiment, the pair i1′-i2′ is stored in the database according to a standard ct. In non-limiting embodiments, the standard ct is defined among:
a vehicle identification number VIN,
a vehicle license plate,
a communication protocol of the pressure sensor 1,
a configuration of the tires 2.

In a non-limiting example, the configuration of the tires 2 is a single or twin-tire configuration.

Also, in a non-limiting embodiment, the programming method Pr1 further comprises, before the step E16 of research of the pair i1′-i2′, a step E15 noted F15(4, 3, ct, bdd) involving the research of said standard ct in the database bdd. This makes it possible to have a faster research of the pair i1′-i2′ in the database bdd. The research is implemented by the programming device 4. Practically, in a non-limiting example of the standard ct as the vehicle identification number VIN, an operator who uses the programming device 4 will, for example, input the vehicle identification number VIN, which is to be found on a door of the truck 3, for example, through the keyboard 47 of the programming device 4, so that it can launch the research. In a non-limiting embodiment, the vehicle identification number VIN is the chassis number of the vehicle 3.

This way, thanks to the programming method Pr1, the new sensor 1 of the new tire 2 will be recognized by the onboard computer 30 of the truck 3 thanks to its identifier i1 that has been input, when the onboard computer requests to recognize the state of the tire 2 where it is housed.

Thus, the programming method Pr1 is implemented by a programming device 4 for pressure sensors 1 for an electronic tire pressure monitoring system 2 of a vehicle 3. The programming device 4 is described with reference to FIGS. 3 and 4.

In a non-limiting embodiment, the programming device 4 is a TPMS tool (Tire Pressure Monitoring System). This is a tool to monitor the pressure of the tires 2 that makes it possible to communicate with the tire pressure monitoring system 5, in particular with the pressure sensors 1.

As pictured in FIG. 3, the programming device 4 comprises:
an activation module 41,
a reception module 43,
an electronic unit 45.

These various items are described in detail below.

The activation module 41 is configured to activate the pressure sensor 1 (a function noted f410(41, 1, s0)). To do so, the activation module 41 is configured to emit an activation signal s0 toward the pressure sensor 1. The activation signal s0 is a continuous or modulated electromagnetic signal. In a non-limiting embodiment, the activation signal s0 is a low frequency signal BF. In a non-limiting embodiment, the activation signal s0 is emitted at 125 kHz. In another non-limiting embodiment, the activation signal s0 is a Bluetooth™ signal. In a non-limiting embodiment, the emission of the activation signal s0 is made according to the BlueTooth Low Energy™ communication protocol, referenced with the BLE acronym. Thus, the activation signal s0 is a signal called BLE.

The activation module 41 is configured to establish a wireless communication connection with the pressure sensor 1 and comprises an antenna 410 (pictured in FIGS. 3 and 4) that is configured to emit said activation signal s0. It shall be noted that the programming device 4 knows the communication protocol that the pressure sensor 1 uses. Thus, it sends the activation signal s0 using the suitable communication protocol.

In a non-limiting embodiment, the programming device 4 comprises an embedded database that comprises the list of communication protocols for each type of pressure sensor 1. In a non-limiting embodiment, the communication protocols are sorted in the embedded database by trademarks and models of vehicles. In this case, the operator who uses the programming device 4 selects (via a keyboard 47 as pictured in FIG. 4 in a non-limiting example) the trademark, and then the model of the vehicle 3, on which they want to apply the programming method Pr1 before launching said method. Thus, in this embedded database, there are all the vehicles, whose pressure sensors 1 have been programmed or reprogrammed by the programming device 4. In a non-limiting embodiment, the embedded database is the same as the bdd that comprises a set of pairs i1′-i2′.

Thus, after the operator has selected the trademark and the model of the truck 3, the number of communication protocols is restricted to the pressure sensors 1 that have effectively been mounted on the truck 3 and to the programmable pressure sensors 1 compatible with said vehicle 3.

The reception module 43 is configured to receive at least one signal s1 from the pressure sensor 1 after activation (a function noted f430(43, 1, s1)). Indeed, after the activation signal s0, the pressure sensor 1 emits said at least one signal s1 to specify, in particular, that it is active, which means awaken, and ready for programming. In a non-limiting embodiment, said at least one signal s1 is a radiofrequency signal. In a non-limiting embodiment, it is a radiofrequency signal emitted and received between 300 MHz and 500 MHz. In a non-limiting embodiment, it is a radiofrequency signal emitted and received at 433 MHz or 315 MHz. In another non-limiting embodiment, the signal s1 is a Bluetooth™ signal. In a non-limiting embodiment, the reception of the signal s1 is made according to the BlueTooth Low Energy™ communication protocol, referenced with the BLE acronym. Thus, the signal s1 is a signal called BLE. The reception module 43 is configured to establish a wireless communication connection with the pressure sensor 1 and comprises an antenna 430 as pictured in FIG. 3 and configured to receive said at least signal s1.

The electronic unit 45 is configured to:
determine the current position i2 in the vehicle 3 of said activated pressure sensor 1 (a function noted f450(45, i2)),
search in a database bdd a pair i1′-i2′ stored identifier-stored position, in which the stored position i2′ is the current position i2 of said pressure sensor 1 (a function noted f451(45, bdd, i1′-i2′)),
program said pressure sensor 1 with the stored identifier i1′ (a function noted f453(45, 1, i1)).

In a non-limiting embodiment, the electronic unit 45 is, in non-limiting examples, a processor with a memory.

In a non-limiting embodiment, the electronic unit 45 is further configured to:
search said database bdd for a standard ct, according to which the pairs i1′-i2′ are stored in said database bdd (a function noted f454(45, 3, ct, bdd)).

In a non-limiting embodiment, the electronic unit 45 is further configured to:
compare the identifier i1 and the current position i2 of said pressure sensor 1 of said vehicle 3 with all the pairs i1′-i2′ that are stored in said database bdd (a function noted f457(45, i1-i2, bdd (i1′-i2′)),
if no stored identifier i1′ of said pairs i1′-i2′ matches the identifier i1, update the database bdd with a new pair made of said identifier i1 and said current position i2 (a function noted f458(45, bdd, i1-i2)).

In a non-limiting embodiment as pictured in FIG. 3, the programming device 4 comprises said database bdd. It is located in a memory 44 of the programming device 4. The database bdd comprises a set of pairs i1′-i2′ that correspond to each pressure sensor 1 of each tire 2 of the truck 3 when the tires 2 are in a position that matches a stored position i2′ at the given time t.

As pictured in FIG. 3, the programming device 4 further comprises a battery 46.

As pictured in FIG. 4, the programming device 4 further comprises:
a casing 40, made of plastic in a non-limiting example,
a display device 42, such as a screen. In non-limiting examples, the screen is a LCD or a TFT screen,
a keyboard 47, and
an OBD port 49 configured, for example, for the connection of the programming device 4 to the electronic monitoring module 30 of the vehicle 3, in particular through an OBD cable.

In a non-limiting embodiment, the programming device 4 further comprises a communication port 48 as pictured in FIG. 4. In a non-limiting embodiment, the communication port 48 is a USB-type port. The communication port 48 is configured to connect said programming device 4 to an electronic appliance, such as a computer. The communication port 48 can further be configured to be linked to a power outlet to receive the power supply to load said battery 46. Said power outlet can be a mains socket, but also any type of electronic or electric appliance able to supply power to the battery 46, such as a computer.

It shall be noted that the steps E10, E12, E14, E16 E18 above can be implemented thanks to a micro-programmed “software” device, a hardwired logic and/or “hardware” electronic components. In a non-limiting embodiment, the implementation of the steps E14′ and E14″ and/or of the step E15 described above according to the implemented embodiments is also implemented thanks to a micro-programmed “software” device, a hardwired logic and/or “hardware” electronic components.

Thus, the programming device 4 can comprise at least one computer software product including at least one sequence of instructions executable by a treatment unit, such as a microprocessor, or by the treatment unit of a microcontroller, an ASIC, etc., wherein the execution of said sequences of instructions makes the steps E10, E12, E14, E16 and E18 described above possible, and possibly the steps E14′ and E14″ and/or the step E15.

Such a computer program can be written in a ROM-type registrable non-volatile memory or an EEPROM-type or FLASH-type rewritable non-volatile memory. Said computer program can be written in memory at the factory or can be loaded into memory or remotely downloaded in memory. The sequences of instructions can be sequences of instructions in a machine language or sequences in a command language processed by the treatment unit at time of their implementation.

In the non-limiting example of FIG. 3, a computer software product Pg is written in the memory 44 of the programming device 4.

Thus, the computer software product Pg comprises at least one sequence of instructions executable by a data treatment module, wherein the execution of said sequences of instructions makes it possible to implement the steps E10, E12, E14, E16 and E18.

In a non-limiting embodiment, the steps are further the steps E14′ and E14″ and/or the step E15.

The computer software product Pg is incorporated on a non-transitory computer-readable data recording medium Md, in which instructions are stored that, when implemented by a data treatment module, make said data treatment module implement the programming method Pr1 as described above.

In non-limiting embodiments, the non-transitory computer-readable data recording medium Md is an electronic storage device, a magnetic storage device, an optical storage device, an electromagnetic storage device, a semiconductor storage device, or any suitable combination thereof. In non-limiting examples, the non-transitory computer-readable data recording medium Md is a ROM read-only memory or similar, such as a PROM, a erasable read-only memory EPROM or similar such as an EEPROM, a Flash memory, a semiconductor storage device, a DVD, etc. In the non-limiting example of FIG. 3, the non-transitory computer-readable data recording medium Md is the memory 44 described above.

Although the non-transitory computer-readable data recording medium Md is pictured, as in the non-limiting embodiment of FIG. 3, as an unique recording medium, the term non-transitory computer-readable data recording medium must be considered as comprising an unique medium or multiple media.

A non-transitory computer-readable data recording medium Md as used here must not be interpreted as a transitory signal by itself, such as a radio wave, an electromagnetic wave that spreads through a waveguide or any other transmission medium, or a wired electric signal transmission.

So, obviously, the programming method Pr1 can be used by an operator during a maintenance on the truck 3, in particular to change tires 2 of the truck 3 with new tires 2 comprising new pressure sensors 1. Thus, FIG. 5 shows a maintenance method Pr2 for a vehicle 3 according to a non-limiting embodiment, wherein said vehicle 3 comprises an electronic tire pressure 2 monitoring system 5 of said vehicle 3 and said tires 2, said tires 2 each comprising a pressure sensor 1. The maintenance method Pr2 comprises:
in a first step E30 noted F30(2), a change of at least one tire 2 in said vehicle 3 with a new tire 2,
in a second step E31 noted F31(Pr1), an implementation of the programming method Pr1.

So, it shall be noted that the operator who changes the tire(s) 2 reprograms the pressure sensor(s) 1 of said tire(s) 2 thanks to the programming device 4.

Of course, the description of the invention is not restricted to the above-mentioned embodiments and to the above-mentioned field. Thus, in a non-limiting embodiment, the display device 42 and the keyboard 47 of the programming device 4 can be replaced by only one item, such as a touchscreen that makes it possible to display information, on one hand, and to activate functions with dedicated pictograms or by an operator confirming an operation, on the other hand. Also, in other non-limiting embodiments, said standard ct for research in the database bdd can be:
a date and an hour at time of the latest procedure on the vehicle 3,
a name of the user of the tool TPMS,
a geographical position at time of the latest procedure on the vehicle 3.

Thus, the invention described above has notably the following advantages:
it makes it possible to re-associate an identifier i1, which is recognizable by the onboard computer 30 of the vehicle 3, with a current position of a new pressure sensor 1 without requiring a relearning by the onboard computer 30 in the case where it cannot be accessed during a maintenance of the vehicle 3,
it allows the onboard computer 30 to always be able to communicate with a pressure sensor 1 even after a change of tires 2,
its implementation is simple and quick.

What is claimed is:

1. A programming method for pressure sensors of vehicle tires, wherein said programming method comprises:
an activation of at least one programmable pressure sensor;
a reception of at least one signal from said at least one pressure sensor after said activation;
a determination of a current position in the vehicle of said at least one activated pressure sensor;
a research in a database of a pair stored identifier-stored position, in which the stored position is the current position of said pressure sensor; and
a programming of said at least one pressure sensor with the stored identifier.

2. A programming method according to claim 1, characterized in that said database is in a remote server or a memory of a programming device.

3. A programming method according to claim 1, characterized in that said stored identifier is an identifier stored in the onboard computer of said vehicle, and in that said stored position is a stored position in said onboard computer.

4. A programming method according to claim 1, characterized in that said stored identifier is an identifier of the non-programmable pressure sensor.

5. A programming method according to claim 1, characterized in that each step of the programming method is made in sequence for all pressure sensors of said vehicle before the following step, wherein all the steps of the programming method are made for each pressure sensor of said vehicle before moving on to the next pressure sensor.

6. A programming method according to claim 1, characterized in that said pair is stored in the database according to a standard and in that said programming method further comprises, before the step of research of said pair in said database, a research in said database of said standard.

7. A programming method according to claim 6, characterized in that said standard is defined among:
a vehicle identification number;
a vehicle license plate;
a communication protocol of said pressure sensor; and
a configuration of the tires.

8. A programming device of pressure sensors for electronic tire pressure monitoring system of a vehicle, wherein said programming device comprises:
an enabling module configured to activate said pressure sensor;
a reception module configured to receive at least one signal from said pressure sensor after said activation; and
an electronic unit configured to:
determine a current position in the vehicle of said activated pressure sensor;
search a database for a pair stored identifier-stored position, in which the stored position is the current position of said pressure sensor; and
achieve a programming of said at least one pressure sensor with the stored identifier.

9. A programming device according to claim 8, characterized in that said electronic unit is further configured to, before the activation of said pressure sensor, search in said database a standard according to which said pair is stored in the database.

10. A computer software product comprising at least one sequence of instructions executable by a data treatment module, wherein the execution of said sequences of instructions makes it possible to implement the following steps when said sequences of instructions are loaded onto a computer, the steps being:
an activation of at least one programmable pressure sensor;
a reception of at least one signal from said at least one pressure sensor after said activation;
a determination of the current position in the vehicle of said at least one activated pressure sensor;
a research in a database of a pair stored identifier-stored position, in which the stored position is the current position of said pressure sensor; and
a programming of said at least one pressure sensor with the stored identifier.

11. A maintenance method of a vehicle, wherein said vehicle comprises an electronic tire pressure monitoring system of said vehicle and said tires, said tires comprising each a pressure sensor, characterized in that said maintenance method comprises:
a change of at least one tire in said vehicle with a new tire; and
an implementation of the programming method according to claim 1.
